(19) United States
(12) Patent Application Publication
(10) Pub. No.: US 2001/0030599 A1
(43) Pub. Date: Oct. 18, 2001

(54) Device and method for monitoring the interior space of a transport container

(76) Inventors: Uwe Zimmermann, Ludwigsburg (DE); Achim Pruksch, Neudenau (DE); Werner Uhler, Bruchsal (DE)

Correspondence Address: Richard L. Mayer, Esq., Kenyon & Kenyon, One Broadway, New York, NY, 10004, US

(21) Appl. No.: 09/829,112

(22) Filed: Apr. 9, 2001

(30) Foreign Application Priority Data
Apr. 13, 2000 (DE) 1 00 18 302.6

(51) Int. Cl. B60R 25/10; G08B 21/00

(52) U.S. Cl. 340/426; 340/431; 340/568.1

(57) ABSTRACT

A device and a method for monitoring the inside of a transport container, in particular the cargo area of a utility vehicle, one or more sensors linked to an alarm triggering device being provided on or in a wall of the transport container for monitoring the inside of the transport container, the alarm triggering device and/or the sensors being settable so that in a first operating mode it or they may be used for theft prevention and, in a second operating mode, for monitoring load displacements.

### FIELD OF THE INVENTION

The present invention relates to a device for monitoring the interior space of a transport container, as well as to a corresponding method.

### BACKGROUND INFORMATION

German Patent Application No. 196 34 562 A1 describes a device for monitoring the interior space of a transport container, in particular the cargo area of a utility vehicle.

This document proposes that one or a plurality of microwave sensors reacting to a movement within their detection range be arranged on or in a wall of the transport container so that their detection ranges are situated within the monitored interior space. If a sensor responds, measures indicating an extraordinary situation in the cargo area are initiated. The device described in this document is used for monitoring the interior space of a transport container for theft.

When working with a device of this kind, however, there is the risk of a false alarm, for example, due to deflection of a cover caused by the wind in the case of tarpaulin-covered structures or, for example, slipping of the load during travel. On the other hand, a utility vehicle driver cannot be effectively warned prior to the load slipping by monitoring devices of this type since the sensors used only react to relatively large displacements of the load in order to avoid overly frequent false alarms.

German Patent Application No. 196 16 038 A1 describes a method and a measuring device for determining the position of an object. In this method, an optical transmitter and an optical receiver are used, conclusions being drawn from the transmitting angle and the angle under which the receiver receives the beam reflected from an object concerning the resolution cell defined by the angular resolution of the sensor and the receiver in which the object is located, the light beam emitted by the transmitter being modulated for this purpose. The phase difference between the modulation of the transmitted light beam and the modulation of the received beam is measured. The position of the object within the respective resolution cell is calculated from the phase difference.

### SUMMARY OF THE INVENTION

An object of the present invention is to provide a method of monitoring the interior space of a transport container, in particular the load area of a utility vehicle, in which both anti-theft security and indication of a load displacement can be effectively implemented.

According to the present invention, monitoring of the interior space (inside) of a transport container can be performed both for anti-theft security and for load displacement in a simple manner. The sensor signal/alarm signal according to the present invention can be furthermore used for initiating braking intervention and/or engine intervention. It is conceivable, for example, that the sensor signal/alarm signal is transmitted to a corresponding controller (data exchange over CAN bus, for example), through which reduction in the vehicle speed through braking intervention or throttling of the engine injection system can be achieved. Controllers that can be used for this purpose may include vehicle dynamics controllers (FDR controllers) or antilock braking systems/drive slip controllers (ABS/ASR controllers).

According to a preferred embodiment of the device according to the present invention, the sensors and/or the alarm triggering means connected thereto generate a sensor signal or an alarm signal only for a relatively large displacement of at least one element of the load in a first operating mode and generate a sensor signal or an alarm signal even for a relatively small displacement of at least one element of the load in a second operating mode. In order to define the terms used of a relatively large or relatively small displacement, they can be set in relation to the dimension of the inner space of the transport container, for example, in the form of percentages. It would also be conceivable to use absolute numerical values here. However, it is particularly preferred to take into account the weight of the load with respect to the amount of displacement. It is therefore useful to define the amount of displacements as percentages with respect to the size and/or the weight of the load. In this manner it is achieved in a simple manner that during the first operating mode a small load displacement triggers no sensor signal or alarm signal. Thus it can be avoided that an alarm is triggered for a small movement of the load when the transport container, i.e., the vehicle, is stationary. On the other hand, in the second operating mode, the system is sufficiently sensitive to warn the driver of an incipient load displacement. It should be noted here that the term “displacement” includes all forms of movement of the load. For example, tipping of the load can also be mentioned here. Such tipping is determinable in a simple manner using contour monitoring according to the present invention.

Conveniently, with a stationary transport container the first operating mode and with a moving transport container the second operating mode can be automatically set. This measure guarantees optimum monitoring of the interior space of a transport container without the need for the driver to manually switch over the system. The system conveniently determines, by evaluating or determining the vehicle velocity, whether a first (in particular stationary) or a second (in particular moving) operating mode prevails. Appropriate signals can be entered in a controller used via a CAN bus.

Preferably, a generated or triggered sensor signal or alarm signal is sent to an alarm center located outside the transport container. The signal which may be present, for example, in the form of an optical or acoustical signal may be sent, for example, in the absence of the driver, by emitting a radio signal via the vehicle antenna, notifying the driver or a stationary police alarm center.

It has proven advantageous to perform the contour monitoring of the load according to the method of the present invention using triangulation methods. Such methods are reliable and can be performed with relatively simple calculations.

### BRIEF DESCRIPTION OF THE DRAWINGS

FIG. 1 schematically shows a sectioned side view of a trailer which is equipped with the device according to the present invention.

FIG. 2 shows a schematic sectioned rear view of the trailer illustrated in FIG. 1.

FIG. 3 shows a view corresponding to FIG. 2 in which the load has been removed.

FIG. 4 shows a flow chart to further explain the method according to the present invention.

FIG. 5 shows another flow chart to explain how a distinction is made between the two different operating modes according to the present invention.

### DETAILED DESCRIPTION

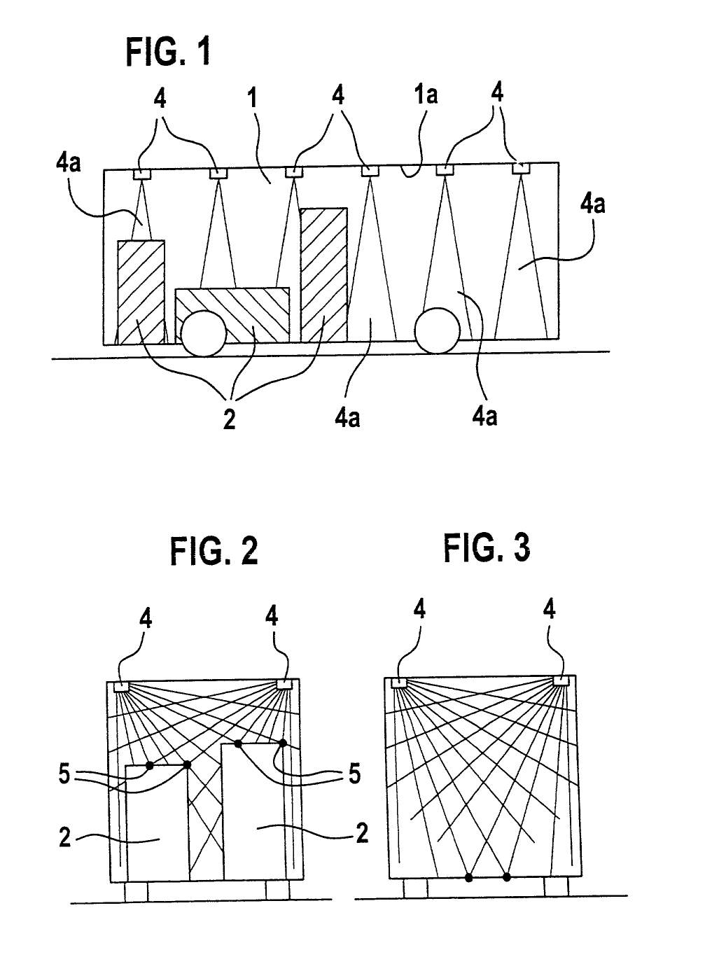

In FIG. 1, a trailer, i.e., the cargo area or transport container of a truck, is labeled with number 1. It should be noted that the teaching according to the present invention can be used in a similar manner for any type of vehicle. This includes, for example, a tractor of a tractor-trailer or even track-bound transport means. Individual elements of the load accommodated in this cargo area 1 are labeled with number 2. On top 1a of cargo area 1 there are a plurality of sensors 4, which are connected by a supply line (not illustrated). Sensors 4 are arranged so that their respective detection ranges indicated by cone 4a are located in cargo area 1. Essentially the entire cargo area 1 can be monitored using a suitable arrangement of sensors 4. It should be noted that the sensors may also be arranged on the side walls or on the bottom of cargo area 1.

Sensors 4 connected to one another are also connected to a computing and analyzer unit (also not illustrated). The contour shape of the elements 2 of the load can be detected, for example, by a suitable triangulation method. A sensor arrangement suitable for performing such a triangulation method is schematically illustrated in FIG. 2. Since triangulation methods are essentially known, no detailed explanation will be given here for the sake of greater clarity of the description. It will only be briefly noted that in FIG. 2 four points of the contour to be detected are illustrated, for example. Individual points 5 can be stored as X-Y values in the analyzer unit.

FIG. 3 shows that elements 2 of the load are no longer located in the detection range of the triangulation system illustrated in FIG. 2. This may have been caused, for example, by a displacement of the load within cargo area 1 or by it having been completely removed.

According to FIG. 3, contours that are different from those illustrated in FIG. 2 are detected by the two sensors shown, i.e., by the analyzer unit. By comparing contour data 5 in FIG. 2 with contour data 5′ in FIG. 3, a displacement of elements 2 of the load from the detection range of sensors 4 can be determined.

When this detected contour difference exceeds a certain settable threshold, which corresponds to a difference threshold value, the required measures can be taken; for example, the driver can be warned via a suitable alarm triggering device (not illustrated) of the displacement of elements 2 of the load.

According to the present invention, different thresholds, i.e., threshold values are provided for a stationary or a moving truck. When the truck is moving, the threshold value is conveniently set, so that an alarm signal is triggered even for a small displacement of elements 2 of the load (i.e., for a relatively small change in contour in the detection range of the sensors). However, when the vehicle is stationary, the threshold value is set relatively high, i.e., an alarm is only triggered for considerable changes in the contour, for example, when elements 2 are completely removed from the detection range of the respective sensors 4. This may provide an effective anti-theft system without any danger of excessively frequent false alarms triggered for a relatively slight displacement of elements 2 of the load.

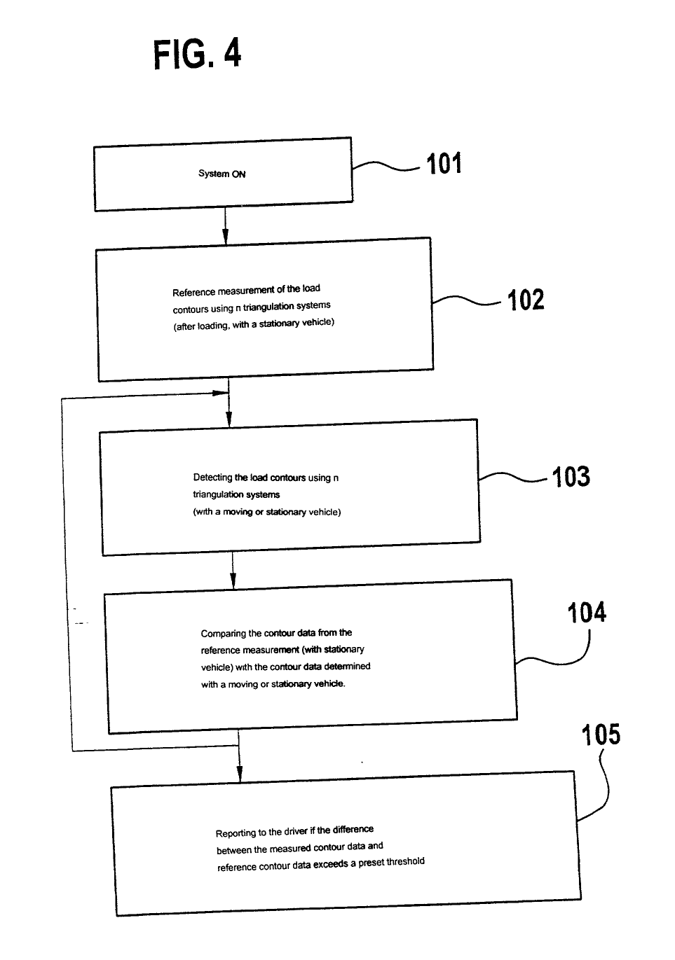

The method according to the present invention is now further elucidated with reference to the flow chart of FIG. 4. After the system is turned on (step 101) a reference measurement of the contours of the load is performed by n triangulation systems, each of which has at least two sensors 4. Step 102 preferably takes place after the stationary vehicle is loaded.

In a subsequent step 103 the contours of the load are detected, in particular in regular intervals, using the n triangulation systems. Step 103 can be performed with a moving or a stationary vehicle.

Step 104 is performed after the respective step 103; in step 104 the contour data from the reference measurement is compared to the contour data obtained during the subsequent measurements.

If the difference between the measured contour data and the reference contour data exceeds a threshold set respectively for the stationary or moving vehicle, the driver is notified, for example, via the above-mentioned alarm triggering device (step 105). If the difference does not exceed the threshold, there is a jump back to step 103.

The monitoring ranges of sensors 4 are determined by suitably selecting the number of transmitted and received beams and their respective angular divergences. As mentioned previously, the contours that can be detected by the sensor system are advantageously determined by triangulation. Thus a tolerance range can be set for an individual system, as explained previously, depending on the application, starting at which a warning is to be given to the driver.

The entire system may have a modular design, for example by the option of cascading the sensors on a bus system (not illustrated), so that a variable number of sensors can be connected to the system depending on the requirements (for example, taking into consideration the size of the cargo area, the required reliability of the monitoring, or the presence of unwieldy goods which occasionally may result in shading).

The sensors can be checked for function and contamination by analyzing the signals that are constantly available (for example, of the load or limits of the cargo area). Contamination of the sensor system can be detected from the constant or periodically occurring signals, for example, through a degradation of the analog voltages generated.

The system according to the present invention allows early detection of load displacements during travel, thus preventing severe damage to the load or serious accidents.

LEDs or diode arrays are preferably used as sensors and have proven to be very sturdy and reliable in practice. Such sensors, which have no mechanical moving parts, are very inexpensively available. These sensors can also be used in other functions, for example in ACC (Automatic Cruise Control) or Stop and Go systems. No costly fine adjustment of the sensors is necessary because the reference measurement is performed after loading. It should be noted that LEDs and diode arrays are only mentioned as examples. Other functionally equivalent components can also be used.

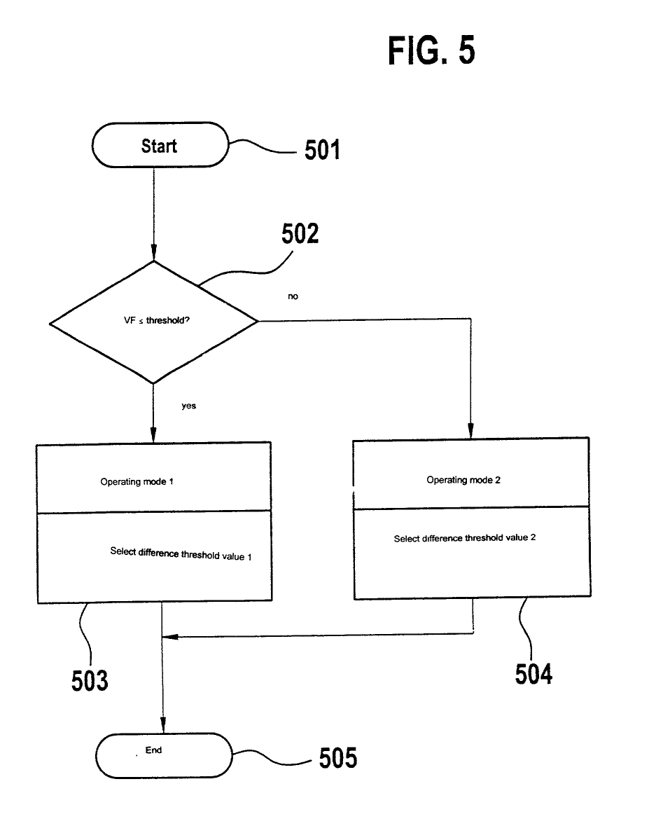

Finally, FIG. 5 shows an exemplary embodiment of the measures according to the present invention for defining different operating modes. After start in step 501, it is determined in step 502 whether the vehicle velocity VF is greater than or equal to a threshold. It should be noted that the determination of the vehicle velocity for defining different operating modes represents only a preferred embodiment. Other suitable vehicle parameters may also be conceivably selected.

If it is determined in step 502 that vehicle velocity VF exceeds the threshold value, it is concluded in step 503 that operating mode 1 prevails to which a first difference threshold value is assigned. This operating mode 1 may be, for example, the state of an essentially stationary vehicle.

However, if it is determined in step 502 that vehicle velocity VF is greater than this threshold, it is determined in step 504 that operating mode 2 prevails (e.g., moving vehicle), to which in turn an appropriate difference threshold value can be assigned. The procedure illustrated can be repeated with any desired frequency to determine the operating mode.

What is claimed is:

1. A device for monitoring an interior space of a transport container, comprising:
an alarm triggering device; and
at least one sensor operatively connected to the alarm triggering device, the at least one sensor being situated one of on and in a wall of the transport container for monitoring the interior space of the transport container,
wherein at least one of (a) the alarm triggering device and (b) the at least one sensor is settable so that it operates to prevent theft in a first operating mode and to monitor load displacements in a second operating mode.

2. The device according to claim 1, wherein the device monitors a cargo area of a utility vehicle.

3. The device according to claim 1, wherein:
in the first operating mode, the at least one of the alarm triggering device and the sensor generates one of an alarm signal and a sensor signal in response to a first displacement of at least one element of a load present in the interior space, and
in the second operating mode, the at least one of the alarm triggering device and the sensor generates one of the alarm signal and the sensor signal in response to a second displacement of at least one element of the load, the first displacement being larger than the second displacement.

4. The device according to claim 1, wherein when the transport container is stationary the first operating mode is automatically set.

5. The device according to claim 1, wherein when the transport container is moving the second operating mode is automatically set.

6. The device according to claim 3, wherein the generated signal is transmitted to an alarm center located outside of the transport container.

7. A method for monitoring an interior space of a transport container, comprising:
performing a reference measurement for representing contours of a load located in the interior space;
detecting the contours of the load in predefined time intervals;
comparing the contours from the reference measurement with the contours detected in the predefined time intervals; and
triggering one of a sensor signal and an alarm signal when a predefined difference threshold value between the contours from the reference measurement and the contours detected in the predefined time intervals is exceeded, the predefined difference threshold value being higher in a first operating mode than in a second operating mode.

8. The method according to claim 7, wherein a cargo area of a utility vehicle is monitored.

9. The method according to claim 7, wherein the first operating mode corresponds to when the transport container is stationary, and the second operating mode corresponds to when the transport container is moving.

10. The method according to claim 7, wherein the load contours are detected using triangulation methods.
